(19) United States
(12) Patent Application Publication
(10) Pub. No.: US 2024/0152936 A1
(43) Pub. Date: May 9, 2024

(54) ASSIGNING TEST PERIODS OF GEOGRAPHIC REGIONS TO TREATMENT OR CONTROL GROUPS FOR A/B TESTING

(71) Applicant: Maplebear Inc. (dba Instacart), San Francisco, CA (US)

(72) Inventors: Tim Hesterberg, Seattle, WA (US); Rahul Makhijani, Daly City, CA (US)

(21) Appl. No.: 17/982,941

(22) Filed: Nov. 8, 2022

(51) Int. Cl. G06Q 30/02

(52) U.S. Cl. CPC G06Q 30/0201

(57) ABSTRACT

Test periods for an A/B test to be run in one or more geographic regions are set. Each test period in each geographic region is assignable to a treatment or control group. For each of plural test periods other than a first test period and for each geographic region, a biased probability indicating a probability of the test period being assigned to the treatment group of the A/B test is set. The biased probability is set based on a log of previous assignments for the geographic region indicating respective assignments for each previous test period including the first test period. The test period of the geographic region is assigned to one of the treatment and control groups of the A/B test based on the set biased probability. The A/B test is run in the geographic region and during the test period based on the assignment.

### BACKGROUND

In current online concierge systems, pickers (e.g., shoppers) fulfill orders at retailers or other physical warehouses on behalf of customers as part of an online shopping concierge service. The system provides an interface for customers to select items offered by physical warehouses and specify delivery options. Pickers are sent to warehouses with instructions to fulfill the orders. Based on availability and delivery costs including distance and time costs, the online concierge system may combine orders into optimized delivery routes, e.g., a picker may deliver two orders from a single store to different customers.

To improve performance of the online concierge system, it may be desirable to optimize different stages of the order fulfillment process. Optimizing the different stages of the order fulfillment process may include, for example, increasing user (e.g., picker, customer, retailer) interaction with the system, decreasing order fulfillment time, reducing costs, and the like. To perform such optimizations, the online concierge system may conduct various experiments (e.g., A/B tests) that adjust one or more variants (e.g., parameters, functionalities, features, algorithms, processes, and the like) of the system to determine the effects of the variants on the system.

A/B testing (e.g., split testing) refers to a randomized experimentation process wherein two or more versions of a variable (e.g., two versions of the online concierge system, one with the one or more variants being tested, and one without the one or more variants) are tested before rolling them out in production. A/B tests are randomized experiments where the unit of experimentation is randomly subjected to a control or test (e.g., treatment) variant.

One common issue in A/B testing is network effects or spillover effects that occur between treatment and control, e.g., when the actions of one picker affect nearby pickers. For example, in case of a test that provides incentives to pickers to deliver more orders, pickers in the treatment group may accept more orders, leaving fewer orders available for nearby pickers that are randomly assigned to the control group, preventing a clean comparison of how the system would perform if the incentives were rolled out globally, compared to the status quo.

As a result, in A/B testing of the online concierge system that ignores such network effects, it is difficult to determine whether an updated version of the online concierge system with one or more variants should be rolled out in production. This may lead to a sub-optimal version of the online concierge system to remain in production, which may lead to other problems like unnecessary consumption of high network bandwidth or computing resources which may be avoidable by rolling out the updated version.

### SUMMARY

This disclosure generally relates to computer hardware and/or software for testing efficacy of one or more variants of an online concierge system. More specifically, the disclosure relates to algorithms for assigning test periods of geographic regions (e.g., countries, states, counties, metropolitan areas, cities, towns, zip codes, neighborhoods, company-specific defined zones, or other similar clearly defined geographic areas) to treatment groups or control groups while reducing conflict and swarming and maintaining balance. That is, this disclosure pertains to an online concierge system that delivers products or services in different geographic regions and that also runs A/B tests on the online concierge system to determine the effects of various treatments (e.g., adjusted parameters, one or more variants). When running the A/B tests, the system assigns the different geographic regions to either a control group or a treatment group at a region-level for each test period (e.g., each test day) of the A/B test (e.g., two-armed trials). Techniques disclosed herein are described in the context of two-armed trails. In other embodiments, the techniques disclosed herein may also be applicable to experiments with more than two arms (e.g., one or more control groups and one or more test groups). The system operates with the adjusted parameters or variants in the regions and test periods assigned to the treatment group, while operating with the original (non-adjusted) parameters in the geographic regions and test periods assigned to the control group. The system can then compare the results between the control group and the treatment group to analyze the effects of the adjusted parameters and determine whether to roll out (e.g., apply) the adjusted parameters globally, e.g., for all users in all regions. However, when running such experiments in multiple geographic regions and/or running multiple experiments in the same geographic region, it is difficult to isolate how changes to the one or more parameters impact shopper performance or online concierge system performance, thereby making it difficult to know which adjustments or changes to apply to the system at a global level. Another common issue in A/B tests is that experimental units differ, and purely random assignment could be unbalanced, e.g., with a preponderance of high-value customers or regions in either the treatment or control group. Common approaches to reduce the effect of this imbalance include switchback experiments, where a unit is randomly assigned to one group for the first period, then switched to the other arm for the next.

To overcome the above problems, the system assigns the geographic regions using a random sequential algorithm that reduces conflict (e.g., interference between multiple experiments running simultaneously within the same geographic region; when assignments for a region are correlated between experiments) and swarming (e.g., interference between geographic regions of the same experiment; when assignments for different regions are correlated within the same experiment) while maintaining balance (e.g., predetermined ratio (which may be exact or approximate) between number of days assigned to the treatment group and number of days assigned to the control group) among the (sequential) assignments in a given geographic region for a given experiment. The balance may be considered on an overall basis (e.g. assignment to treatment 7 out of 14 days) or on some other granular basis, e.g. on a day-of-week basis (e.g. assignment to treatment 1 of 2 days for each day of week in a 14 day experiment), weekday/weekend, holiday/non-holiday, week (approximately half of week 1 assigned to treatment, similarly for subsequent weeks), or on combinations of these factors simultaneously (e.g. week and day of week). For example, the online concierge system may assign each day of each geographic region to a control group or a treatment group by sampling the control/treatment assignment using a probability that is biased based on a log of previous assignments. That is, the assignment probabilities are adjusted dynamically based on previous assignments so that the instantaneous assignment probabilities may be something other than 50-50, but when averaged across all assignments in the assignment log, the assignments are unbiased and achieve the desired balance (e.g., 50-50 balance between treatment and control).

In one or more embodiments, a computer-implemented method includes a plurality of steps. In particular, the method includes a step of setting test periods for an A/B test to be run in one or more geographic regions. Each of the test periods in each of the one or more geographic regions is assignable to one of a treatment group and a control group of the A/B test. The method further includes, for each of a plurality of the test periods other than a first test period and for each of the one or more geographic regions, a step of setting a biased probability indicating a probability of the test period of the geographic region being assigned to the treatment group of the A/B test. The biased probability is set based on a log of previous assignments for the geographic region indicating respective assignments for each previous test period including the first test period. Still further, the method includes, for each of the plurality of the test periods other than the first test period and for each of the one or more geographic regions, a step of assigning the test period of the geographic region to one of the treatment group and the control group of the A/B test based on the set biased probability. And still further, the method includes, for each of the plurality of the test periods other than the first test period and for each of the one or more geographic regions, running the A/B test in the geographic region and during the test period based on the assignment.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 is a block diagram of a testing module of the online concierge system of FIG. 2, in accordance with one or more embodiments.

FIG. 4 illustrates the logic for reducing conflict, in accordance with one or more embodiments.

FIG. 5 illustrates the logic for reducing swarming between geographic regions of the same experiment, in accordance with one or more embodiments.

FIG. 6 is a flowchart of a method for assigning test periods of geographic regions to treatment groups or control groups while reducing conflict and swarming and maintaining balance, in accordance with one or more embodiments.

### DETAILED DESCRIPTION

Randomly assigning geographic regions and test periods to treatment/control groups can give unbalanced assignments, negatively affecting experiment estimates. For example, a particular large city could be assigned to treatment all 14 days of an experiment. Using a next-day or next-week switchback improves the imbalance for any given geographic region, but exacerbates other problems that also impair experiment estimates, e.g., interference between experiments (e.g., conflict), and interference between regions within an experiment (e.g., swarming).

Interference between experiments (e.g., conflict, inter-experiment interference) may refer to a situation where two experiments are running over a same test period in a same region (e.g., at least a partial overlap; experiments at least partially overlapping over some test periods in some of the same regions). In this case, if the geographic region has the same treatment/control sequence of assignments in both experiments (e.g., assignment sequence of TTTCCTCCCTTTCC for both experiments over 14 days in the same region), then it is not possible to separate the effect of one experiment from the other on that geographic region, and estimates for one experiment are confounded by the other. Similarly, in such a case, if the two experiments in the particular geographic region are assigned the exact opposite treatment/control sequence (e.g., assignment sequence of TTTCC over 5 days for Experiment 1, and assignment sequence of CCCTT over the same 5 days and same region for Experiment 2), then it is also not possible to separate the effects of the two experiments in that region, because metrics that are correlated with treatment in one experiment are equally correlated with control in the other experiment. Further, there could be partial imbalance, say the same treatments on 13 days of a 14-day period. Thus, for example, if the experiment is 14 days long, conflict is minimal if there are 7 days with the same assignment, and the other 7 days with the opposite assignment, and the conflict is maximum in case of all or none of the days having the same assignment.

Interference between geographic regions within the same experiment (e.g., swarming, intra-experiment interference) may refer to a situation where the same experiment is running in two or more geographic regions during the same test periods and treatment/control assignments are correlated. For example, if two regions have the same assignments for all 14 days of an experiment, then it is impossible to distinguish the effects of the treatment from day effects (that some days (e.g., weekday vs. weekend) would have higher values for metrics, regardless of treatment or control) within those two regions. Particularly if those regions are large, this negatively effects the quality of results from the experiment. For example, if the experiment is 14 days long, swarming between two geographic regions is minimal if there are 7 days with the same assignment, and the other 7 days with the opposite assignment, and the swarming between the two geographic regions is maximum if all or none of the days have the same assignment.

The random sequential algorithm (or suite of algorithms) according to the present disclosure reduces the above-described conflict and swarming while maintaining balance (e.g., an experiment is balanced if each geographic region is assigned to the treatment group and the control group for the same number (or substantially the same number) of test periods) among the assignments to the geographic regions. For example, the algorithm uses a “biased coin flipping” method to assign the test periods of the geographic regions to the control/treatment groups.

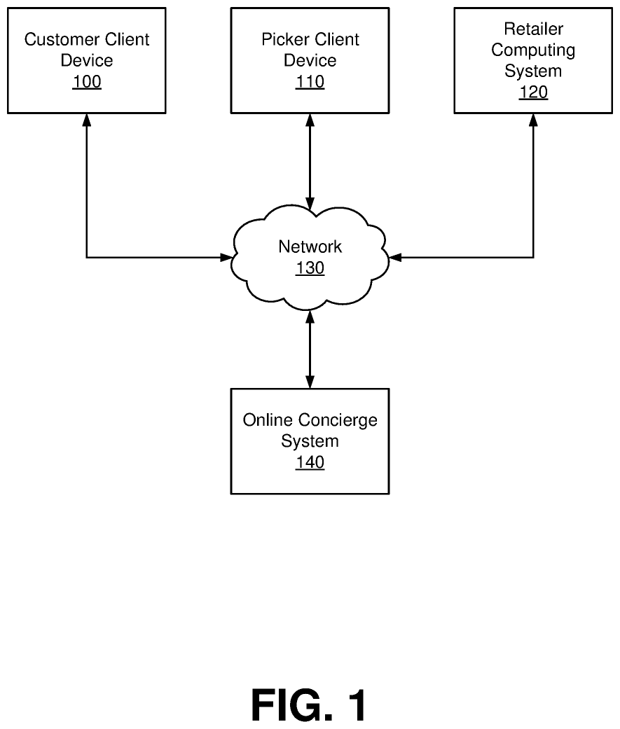

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item,” as used herein, means a good or product that can be provided to the customer through the online concierge system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding, or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availability. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provides portions of the payment from the customer to the picker and the retailer.

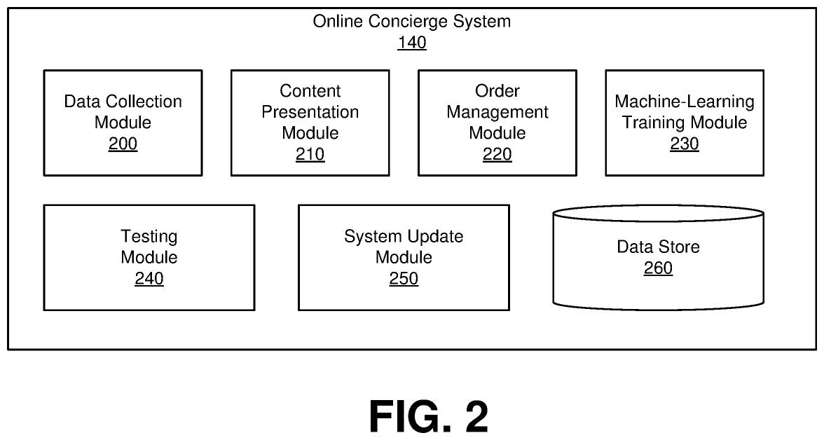

As an example, the online concierge system 140 may allow a customer to order groceries from a grocery store retailer. The customer's order may specify which groceries they want delivered from the grocery store and the quantities of each of the groceries. The customer's client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine-learning training module 230, a testing module 240, a system update module 250, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has services orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine learning training module 230 trains machine learning models used by the online concierge system 140. The online concierge system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross-entropy loss function. The machine learning training module 230 updates the set of parameters for the machine learning model based on the score generated by the loss function. For example, the machine learning training module 230 may apply gradient descent to update the set of parameters.

The testing module 240 is configured to test the above-described functionalities of the online concierge system 140 described in FIGS. 1-2, or to test new functionalities of the online concierge system 140, prior to rolling them out for all users of the online concierge system 140. For example, the data store 260 may store one or more beta versions of one or more modules of the online concierge system 140 that are being tested prior to being rolled out. A beta version of the online concierge system 140 may be a version that includes one or more variants that are being tested using testing techniques such as A/B testing.

The one or more variants may be associated with any aspect of the online concierge system 140 and may be, e.g., to incentivize user (e.g., picker, customer, retailer) interaction with the system, decrease order fulfillment time, decrease order delivery time, reduce order pickup time, reduce cost, and the like. For example, when a customer places an order, it may be desirable to optimize the process of how the distance and time costs from the customer address to the store is predicted. As another example, it may be desirable to optimize the routing process of selecting which store should source an order based on availability and delivery costs, and/or the process for combining orders into delivery routes (e.g., a picker may deliver two orders from a single store to different customers). As yet another example, it may be desirable to optimize the matching process for matching the delivery routes to pickers who might be eligible to fulfill these orders, to minimize costs and late deliveries. One or more experiments (e.g., A/B experiments or tests) may be designed to test different versions of the system that optimize one or more of the above illustrated aspects of the system.

The online concierge system 140 may be operational to provide the online concierge delivery services in a plurality of geographic regions, each geographic region being a geographical area formed around customer delivery addresses. For example, geographic regions may be countries, states, counties, metropolitan areas, cities, towns, zip codes, neighborhoods, company-specific defined zones, or other similar clearly defined geographic area. To minimize network or spillover effects when A/B testing to optimize the system 140, the testing module 240 implements a random sequential algorithm that randomly assigns whole geographic regions to treatment or control groups, instead of assigning individual users to the groups.

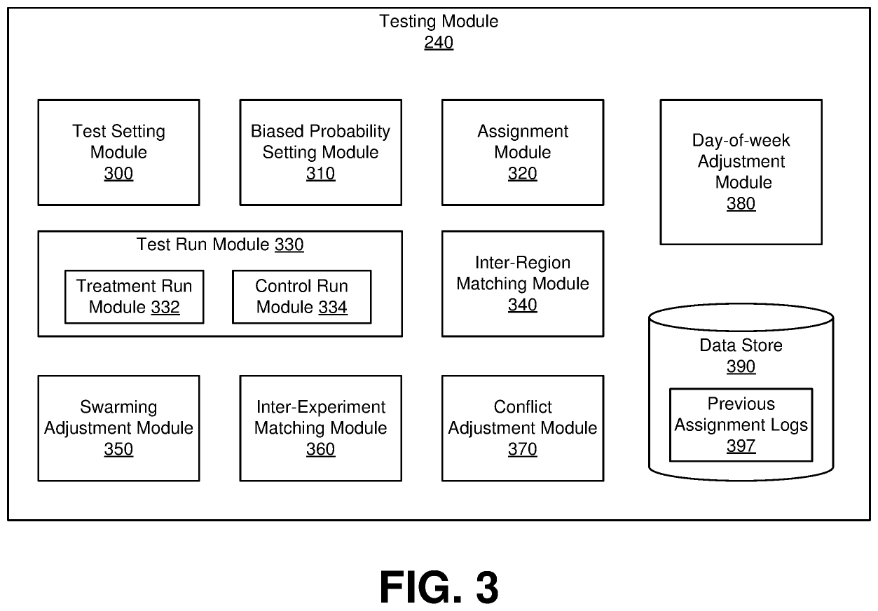

In some embodiments, the random sequential algorithm implemented by the testing module 240 may run experiments (e.g., A/B tests based on each “region-day” combination as a unit) where, a given geographic region is assigned to a treatment (T) group during some test periods (e.g., days) of the experiment and assigned to a control (C) group during other test periods. A test period may have a predetermined length of time a total duration of the experiment is broken down into (e.g., an experiment designed to run for 14 days with a new assignment being made on each day) or a variable duration (e.g., running as many days as needed until a desired accuracy is achieved). For example, each test period may be one day (24 hours) long and the assignment to treatment or control group may be for the day. As other examples, each test period may be 8-hours, 12-hours, 48-hours, and the like, and the duration of the test may be divided into the test periods having equal length. The algorithm may be configured to reduce conflict and swarming while maintaining either exact or approximate balance by introducing dependence between experiments and/or between geographic regions within an experiment. The testing module 240 is described in greater detail in connection with FIG. 3 below.

The system update module 250 is configured to update the online concierge system 140 based on test results of a test performed by the testing module 240. For example, after running an A/B test where two versions (e.g., original version and adjusted version) of the online concierge system 140 were tested in one or more geographic regions over a total duration of the A/B test, the testing module 240 compares the results between the control group and the treatment group to analyze the effects of the adjusted version relative to the original version and determine whether to roll out the adjusted version globally for all users.

The data store 260 stores data used by the online concierge system 140. For example, the data store 260 stores customer data, item data, order data, and picker data for use by the online concierge system 140. The data store 260 may also store different versions of the online concierge system 140 currently under testing by the testing module 240. Still further, the data store 260 stores trained machine learning models trained by the machine learning training module 230. For example, the data store 260 may store the set of parameters for a trained machine learning model on one or more non-transitory, computer-readable media. The data store 260 uses computer-readable media to store data and may use databases to organize the stored data.

FIG. 3 is a block diagram of the testing module 240 of the online concierge system 140 of FIG. 2, in accordance with one or more embodiments. The block diagram illustrated in FIG. 3 includes a test setting module 300, a biased probability setting module 310, an assignment module 320, a test run module 330, an inter-region matching module 340, a swarming adjustment module 350, an inter-experiment matching module 360, a conflict adjustment module 370, a day-of-week adjustment module 380, and a data store 390. The test run module 330 may include a treatment run module 332 and a control run module 334. The data store 390 may include previous assignment logs 397 for different regions and/or different A/B tests. Alternative embodiments may include more, fewer, or different components from those illustrated in FIG. 3, and the functionality of each component may be divided between the components differently from the description below. Additionally, each component may perform their respective functionalities in response to a request from a human, or automatically without human intervention.

The test setting module 300 is configured to set one or more tests for testing one or more variants of the online concierge system 140. The test setting module 300 may set an A/B test to run for a total duration (or for a dynamically determined duration), and in one or more identified geographic regions. For example, the A/B test may be set to run for a period of 14 days (e.g., total number of test days, or total duration) simultaneously in San Francisco, San Mateo, and Marin counties, where each test period is one day long, and where for each region and for each day, the region-day may be assignable to one of a treatment group and a control group of the A/B test, based on the operation of the random sequential algorithm. The test setting module 300 may be configured to set multiple tests having corresponding total durations and identified one or more geographic regions, where the multiple tests may be set to run in parallel in the same geographic region during the same test period.

The biased probability setting module 310 may be configured to set a biased probability indicating a probability of a particular test period of a particular geographic region of a particular A/B test set by the test setting module 300 being assigned to the treatment group of the A/B test. To set the probability, the biased probability setting module 310 may use a “biased coin” approach, in which the probability for the particular test period for being assigned to either treatment group or control group is equal (i.e., random assignment), with bias added depending on previous assignments. That is, the biased probability setting module 310 may set the biased probability for the particular test period based on a log of previous assignments 397 for the particular geographic region indicating respective assignments for each previous test period including a first test period for the particular A/B test. The log of previous assignments 397 may be stored in data store 395 and may specify, for the particular A/B test in the particular geographic region, the sequence of assignments for each elapsed test period, and the log of previous assignments 397 may be updated as new assignments are made for each new test period. For example, in case of an A/B test set to run for 14 days in a given region, suppose seven days have elapsed and the assignment module 320 has assigned the first three days to the treatment group and the next four days to the control group, the log of previous assignments 397 stored in the data store 395 for the A/B test in the given region may store data corresponding to the sequence TTTCCCC.

The assignment module 320 may assign the particular test period of the particular geographic region to one of the treatment groups and the control group of the particular A/B test based on the biased probability set by the biased probability setting module 310. And the test run module 330 may run the particular A/B test in the particular geographic region and during each respective test period based on the assignment of the test period to the one of the treatment group and the control group by the assignment module 320.

The process of setting the biased probability for test periods of geographic regions by the biased probability setting module 310, assigning the test periods of the geographic regions to one of the treatment group and the control group by the assignment module 320, and running the A/B test during the test periods and in the geographic regions by the test run module 330, may be repeated for each of a plurality of the test periods other than a first test period and for each of one or more geographic regions, based on the settings of the A/B test (e.g., based on a set total duration and based on identified one or more geographic regions) set by the test setting module 300.

When assigning the test periods for the geographic region to one of the treatment group and the control group for the particular A/B test, the assignment module 320 may randomly assign the first test period of the geographic region to one of the treatment group and the control group. That is, the biased probability for the first period may be 50:50 for treatment and control, and subsequent biased probability calculations for subsequent test periods of the geographic region by the biased probability setting module 310, and corresponding assignments by the assignment module 320, may be based on the (randomly made) assignment for the first period of the geographic region.

Further, the biased probability setting module 310 may set the biased probability for each of the plurality of the test periods other than the first test period and for each of the one or more geographic regions, such that a treatment-to-control ratio in the log of previous assignments 397 trends toward a predetermined ratio. The predetermined ratio may be preset by the test setting module 300. The treatment-to-control ratio may be a ratio of a number of the test periods of the particular geographic region assigned to the treatment group to a number of the test periods of the particular geographic region assigned to the control group in the log of previous assignments 397. For example, the test setting module 300 may set the predetermined ratio of the treatment-to-control ratio to be 1:1, so that the algorithm will bias the probability to assign half (or substantially half) of the test periods to treatment and the other half to control. As another example, the test setting module 300 may set the predetermined ratio of the treatment-to-control ratio to be 75:25. The predetermined ratio may be changeable or set by a user.

In some embodiments, the test setting module 300 may set a target number of treatment days for the A/B test. And then, for each region, and for each test period, the assignment module 320 may assign the first test period randomly to one of the treatment and control groups, and the biased probability setting module 310 may track the number of treatment test periods previously assigned in the region based on the log of previous assignments 397, and set a biased probability for the next test period that is inversely related to the ratio of the remaining treatment test periods and the total test periods left. For example, in case of an A/B test set to run for 14 days in a given region, suppose the target number of treatment days is set to 7, and suppose assignment module 320 assigns the first three days to the treatment group, then on the fourth day of the test, the biased probability set by the biased probability setting module 310 may be 4/11, based on the remaining treatment test periods (=4), and the total days left (=11). In some embodiments, the predetermined ratio may indicate an approximation, e.g. approximately 7 treatment days in a 14-day experiment. Such assignments may have other desirable properties, such as flexibility for handling experiment lengths that are not fixed in advance, and lower interference between regions and experiments than would occur with exact ratio. In some embodiments, the experiment length may not be preset, and the experiment end may or may not be known in advance. For example, assignment module 320 may be configured to provide approximate balance regardless of the experiment length and/or exact balance if enough advance notice is provided for the end date.

Based on the assignment of the test period of the geographic region, either the treatment run module 332 or the control run module 334 may run the A/B test in the geographic region and during the test period. In some embodiments, for the A/B test set by the test setting module 300, in each geographic region of the test and for each test period of the A/B test that is other than the first test period and that is assigned to the treatment group, the treatment run module 332 presents a first version of the online concierge system 140 to online users (e.g., customers, pickers, retailers), the first version including one or more variants of the online concierge system 140 that are being tested by the A/B test Similarly, for the A/B test set by the test setting module 300, in each geographic region of the test and for each test period of the test that is other than the first test period and that is assigned to the control group, the control run module 334 presents a second version of the online concierge system 140 to the online users (e.g., customers, pickers, retailers), the second version not including the one or more variants of the online concierge system 140 that are being tested by the A/B test set by the test setting module 300. After completion of the total number of test periods based on the set total duration of the A/B test, the system update module 250 of FIG. 2 may compare the results of the A/B test run by the treatment run module 332 and the results of the A/B test run by the control run module 334, and determine whether or not to update the online concierge system 140 to include the one or more variants of the first version based on the comparison results.

As explained previously, the system assigns the geographic regions and test periods using the random sequential algorithm that reduces conflict and swarming while maintaining balance. To reduce swarming, the testing module 240 may implement functionality provided by the inter-region matching module 340 and the swarming adjustment module 350. Swarming between geographic regions within the same experiment refers to a situation where the same experiment is running in multiple geographic regions in the same test period.

The inter-region matching module 340 is configured to determine a number of test periods of a region of an A/B test whose assignments match with assignments of test periods of each of one or more other regions where the A/B test is being run in parallel. For example, the inter-region matching module 340 may compare the log of previous assignments 397 for a first region of the A/B test with the log of previous assignments 397 for a second region of the A/B test to determine based on the comparison, the number of test periods from among the elapsed number of test periods running in parallel in the two regions that have the same assignments (i.e., for a given day, both regions are assigned to treatment, or both are assigned to control).

The swarming adjustment module 350 may determine a swarming adjustment factor for a given test period of a given geographic region based on the number of matching test periods and the number of elapsed test periods. Based on the swarming adjustment factor, the swarming adjustment module 350 may adjust the biased probability for the given test period of the given geographic region by the biased probability setting module 310 to account for the inter-region swarming. For example, an A/B test may run concurrently in first and second geographic regions. For the first geographic region of the A/B test and for each of the plurality of the test periods other than the first test period, the biased probability setting module 310 may set the biased probability for the test period based on the log of previous assignments 397 for the first geographic region indicating respective assignments of each previous test period including the first test period, and based on the treatment-to-control ratio in the log of previous assignments 397 for the first geographic region to maintain the predetermined ratio for the first geographic region between treatment/control. Based on the set biased probability for the test period, the assignment module 320 may assign the test period for the first geographic region to one of the treatment group and the control group.

In this case, the testing module 240 may be configured so that assignments for a second geographic region for the A/B test may be made between treatment/control to not only achieve balance between the assignments within the second geographic region, but to also reduce swarming with the assignments in the first geographic region. More specifically, for a second geographic region of the A/B test, and for each of the plurality of test periods other than the first test period, the biased probability setting module 310 may set the biased probability for the test period based on the log of previous assignments 397 for the second geographic region indicating respective assignments of each previous test period including the first test period, and based on the treatment-to-control ratio in the log of previous assignments 397 for the second geographic region to maintain the predetermined ratio for the second region as set by the test setting module 300. Further, based on the log of previous assignments 397 for the first geographic region and the log of previous assignments 397 for the second geographic region, the inter-region matching module 340 may determine a number of matching test periods having the same assignments. For example, if the log of previous assignments for the first geographic region is “TTTCCC” and the log of previous assignments for the second geographic region is “TCTCT”, and we are now determining the assignment for the second geographic region for the 6^{th} day, the inter-region matching module 340 may determine the number of matching test periods as 3 (i.e., 1^{st}, 3^{rd}, and 4^{th} days). Still further, the swarming adjustment module 350 may determine a swarming adjustment factor for the test period based on the determined number of matching test periods and a number of elapsed test periods prior to the test period. The swarming adjustment module 350 may be configured to determine the swarming adjustment factor such that a ratio between the determined number of matching test periods and the number of elapsed test periods prior to the test period trends toward a predetermined ratio. The predetermined ratio between the matching/elapsed test periods may be set by the test setting module 300. For example, the predetermined ratio between the matching/elapsed test periods may be set as 50% (i.e., equal or substantially equal number of matching and non-matching periods).

Continuing with the above example where we are determining the assignment for the second geographic region for the 6^{th} day, the number of matching test periods=3 and the number of elapsed test periods prior to the test period=5. The swarming adjustment module 350 may then adjust the biased probability set for the test period by the biased probability setting module 310 based on the swarming adjustment factor. In the above example, since 3 out of 5 test periods have matching assignments with the first region, the swarming adjustment factor determined by the swarming adjustment module 350 may adjust the biased probability set by the biased probability setting module 310 to bias the set biased probability toward a non-matching assignment for the test period (i.e., bias toward T for the 6^{th} test period of the second geographic region). The assignment module 320 may then assign the test period for the second geographic region to one of the treatment group and the control group based on the adjusted biased probability for the test period. The A/B test is thus run concurrently in the first and second geographic regions based on the respective assignments.

To reduce interference between experiments running in parallel in the same region(s), the testing module 240 may utilize functionality of the inter-experiment matching module 360 and the conflict adjustment module 370. Interference between experiments may refer to a situation where two experiments are running in the same test period and in the same geographic region (e.g., two experiments running in the same region-day). The inter-experiment matching module 360 is configured to determine a number of test periods of a region for a first A/B test whose assignments match with test periods of each of one or more other A/B tests in the same region. For example, the inter-experiment matching module 360 may compare the log of previous assignments 397 for a first A/B test in a given region with the log of previous assignments 397 for a second A/B test in the same region to determine based on the comparison, the number of test periods from among the elapsed number of test periods in the two A/B tests running in parallel in the same region that have the same assignments (e.g., number of days where both tests are assigned to treatment, or both are assigned to control).

The conflict adjustment module 370 may determine a conflict adjustment factor for a given A/B test in a given test period of a geographic region based on the number of matching test period assignments between the given A/B test and one or more other A/B tests that are also running in parallel in the same geographic region. Based on the conflict adjustment factor, the conflict adjustment module 370 may adjust the biased probability for the given test period for the given A/B test set by the biased probability setting module 310 based on the conflict adjustment factor to account for interference between experiments in the same region.

For example, first and second A/B tests may run concurrently in the same geographic region during overlapping days based on the respective settings for the first and second A/B tests set by the test setting module 300. For the first A/B test in the geographic region and for each of the plurality of the test periods other than the first test period of the first test, the biased probability setting module 310 may set the biased probability for the test period based on the log of previous assignments 397 for the first A/B test in the geographic region indicating respective assignments of each previous test period including the first test period, and based on a treatment-to-control ratio in the log of previous assignments 397 for the first A/B test in the geographic region. Further, the assignment module 320 may assign the test period for the first A/B test in the first geographic region to one of the treatment group and the control group based on the set biased probability for the test period.

Still further, for the second A/B test and in the same geographic region, the assignment module 320 may randomly assign the first test period to one of the treatment group and the control group. And, for the second A/B test in the geographic region and for each of the plurality of the test periods other than the first test period, the biased probability setting module 310 may set the biased probability for the test period based on the log of previous assignments 397 for the second A/B test in the first geographic region indicating respective assignments of each previous test period including the first test period, and based on a treatment-to-control ratio in the log of previous assignments 397 for the second A/B test in the geographic region.

And still further, based on the log of previous assignments 397 for the first A/B test and the log of previous assignments 397 for the second A/B test, the inter-experiment matching module 360 may determine a number of matching test periods having the same assignments in the geographic region. For example, if the log of previous assignments for the first A/B test is “TTTCCC” and the log of previous assignments for the second A/B test in the same region is “TCTCT,” the inter-experiment matching module 360 may determine the number of matching test periods as 3 (i.e., 1^{st}, 3^{rd}, and 4^{th} periods), and we are determining the assignment for the 6^{th} test period of the second A/B test. The conflict adjustment module 370 may determine a conflict adjustment factor for the test period based on the determined number of matching test periods and a number of elapsed test periods prior to the test period. The conflict adjustment module 370 may be configured to determine the conflict adjustment factor such that a ratio between the determined number of matching test periods and the number of elapsed test periods prior to the test period trends toward a predetermined ratio. The predetermined ratio between the matching/elapsed test periods for the different tests may be set by the test setting module 300. For example, the predetermined ratio between the matching/elapsed test periods may be set as 50%. In the above example, in the second A/B test, the number of matching test periods=3 and the number of elapsed test periods prior to the test period=5.

The conflict adjustment module 370 may then adjust the biased probability set for the test period by the biased probability setting module 310 based on the determined conflict adjustment factor. In the above example, since 3 out of 5 test periods have matching assignments with the first A/B test, the conflict adjustment factor determined by the conflict adjustment module 370 may adjust the biased probability set by the biased probability setting module 310 to bias the set biased probability toward a non-matching assignment for the test period (i.e., bias toward T for the 6^{th} test period of the second A/B test). The assignment module 320 may then assign the test period for the second A/B test to one of the treatment group and the control group based on the adjusted biased probability for the test period. The first and second A/B tests are thus run concurrently in the same geographic region based on the respective assignments.

Thus, the testing module 240 may be configured so that assignments for the second A/B test for the same region may be made between treatment/control to not only achieve balance between the assignments within the region for the second A/B test, but to also reduce conflict with the assignments within the same region for the first A/B test. In the above examples, although the adjustment to the set biased probability is explained separately to adjust for conflict and to adjust for swarming, it follows that it may also be possible to adjust a given test period's biased probability to account for both conflict and swarming, in addition to balance, based on the settings of the corresponding tests as set by the test setting module 300.

The day-of-week adjustment module 380 may be configured to balance the assignments between treatment and control for a day of week (e.g., Sunday). For each of the plurality of the test periods other than the first test period and for each of the one or more geographic regions, the day-of-week adjustment module 380 may determine a day-of-week adjustment factor for the test period of the geographic region based on a treatment-to-control ratio of day-of-week assignments in the log of previous assignments 397 for the geographic region that correspond to a day-of-week of the test period. The day-of-week adjustment module 380 may be configured to determine the day-of-week adjustment factor such that the treatment-to-control ratio of the day-of-week assignments in the log of previous assignments 397 for the geographic region that corresponds to the day-of-week of the test period trends toward a predetermined ratio. The predetermined ratio of the day-of-week assignments in the log of previous assignments 397 may be set by the test setting module 300. For example, the predetermined ratio between treatment/control may be set as 1:1.

For example, in a given A/B test and in a given geographic region, if a first Monday is assigned to the treatment group, the day-of-week adjustment module 380 may determine the day-of-week adjustment factor for the next Monday of the test to bias the probability of assignment to the control group. Customer demand and availability of pickers may be different on different days of the week. For example, the demand may be higher, and picker supply available may be lower, on weekends. By balancing the assignments based on the day of the week, more accurate assessment of the adjusted variants of the online concierge system 140 can be made.

The day-of-week adjustment module 380 may further adjust the biased probability set by the biased probability setting module 310 for a given test period based on the day-of-week adjustment factor for that test period, and the assignment module 320 may assign the test period of the geographic region to one of the treatment group and the control group of the A/B test based on the adjusted biased probability for the test period.

The data store 390 stores data used by the testing module 240. For example, the data store 390 stores data to implement functionality of the different modules of the testing module 240. The data store 390 may also store the previous assignment logs 397 indicating the sequence of assignments made for respective regions and respective A/B tests. The previous assignment logs 397 stored in the data store 390 may be updated as new assignments are made for each test period. The data store 390 uses computer-readable media to store data and may use databases to organize the stored data.

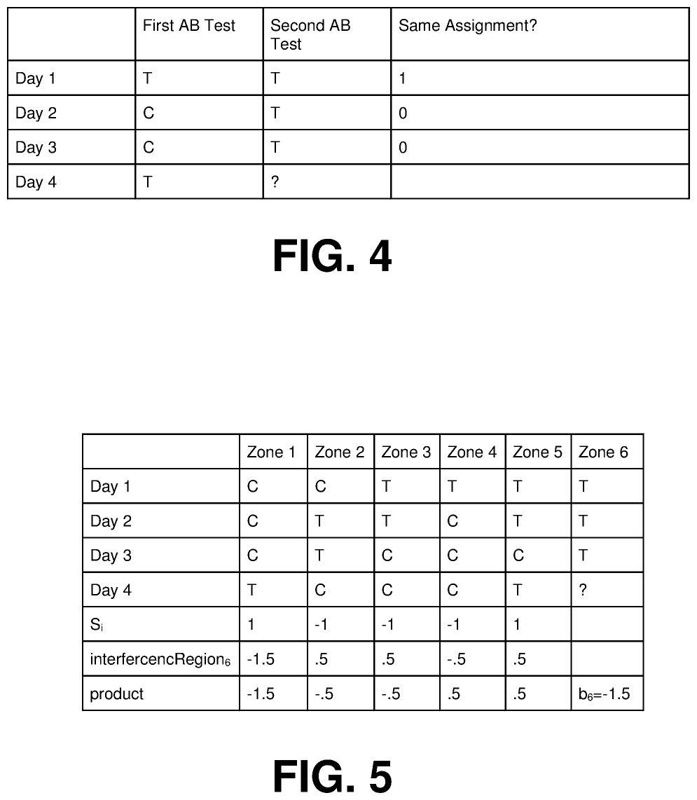

FIG. 4 illustrates the logic for reducing conflict with an example, in accordance with one or more embodiments. FIG. 4 illustrates a situation where a first A/B test in a particular region was assigned to TCCT for four days so far, and a second A/B, test set to run for 14 days where 7 days should be assigned to T, in the same region was assigned to TTT for three days, and the testing module 240 is determining the assignment for the fourth day of the second A/B test. In this case, absent any information about assignment in other experiments, or other regions within this experiment, the random sequential algorithm would assign day 4 of the second A/B test to C and might assign T on day 4 with probability 4/11. But if the same region was assigned to TFFT on days 1 through 4 in the first A/B test, then the algorithm further accounts for the interference between experiments (conflict) in the same region by determining the number of matching days between the experiments. In this case, only 1 out of 3 days have a match between the assignments for the two tests (i.e., Day 1). Hence, the algorithm may bias the assignment probability for the second A/B test toward a match on day 4 (i.e., toward T again). For example, we may define a numerical measure of conflict, say interferenceExperiment=number of days with matching assignments−number of days with non-matching assigments (i.e. 1−2=−1) and use that to adjust the probability for T on day 4 to (4−c interferenceExperiment), where c is a small positive user-defined parameter, where smaller values for c indicate slower progression against conflict.

FIG. 5 illustrates the logic for reducing swarming between geographic regions of the same experiment with an example, in accordance with one or more embodiments. FIG. 5 illustrates a situation where an experiment is set to run in six different regions for 14 days where 7 days should be assigned to T in each region. Assignments have been made for the first 4 days in Regions 1-5, and the testing module 240 is determining the assignment for the fourth day of Region 6.

For the earlier five regions, the algorithm may check the value of interferenceRegion, 6 (which defines swarming between region i and region 6 based on earlier days), and whether that value would be made better or worse by assigning this region to T on day 4. Let Sᵢ=1 if region i is assigned to T and −1 if assigned to C on day 4, and let

$${b}_{6} = {\sum }_{i = 1}^{5} {S}_{i} {interferenceRegion}_{i 6}$$

A positive value for the above equation indicates that earlier regions whose assignment profiles are positively correlated with this region on previous days tended T on day 4 (and negatively correlated regions tended C). Hence, assigning region 6 to C on day 4 would improve overall region interference (swarming). Conversely, a negative sum favors assigning T now. For example, T may be assigned with probability (4−c interferenceExperiment−d(b₆))/11, where d is a small positive number. In the example shown in FIG. 5, interferenceRegion, 6 is −1.5, suggesting a preference for assigning T for Region 6—largely to avoid even worse interference (swarming) with Region 1.

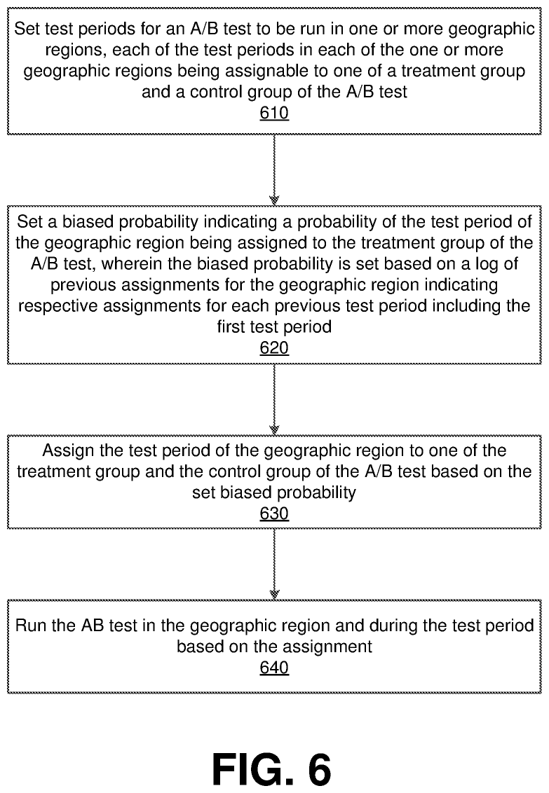

FIG. 6 is a flowchart for a method of assigning test periods of geographic regions to treatment groups or control groups while reducing conflict and swarming, and while maintaining balance, in accordance with one or more embodiments. Alternative embodiments may include more, fewer, or different steps from those illustrated in FIG. 6, and the steps may be performed in a different order from that illustrated in FIG. 6. These steps may be performed by an online concierge system (e.g., online concierge system 140). Additionally, each of these steps may be performed automatically by the online concierge system without human intervention.

The test setting module 300 of the online concierge system 140 may set (Block 610) test periods for an A/B test to be run in one or more geographic regions. Each of the test periods in each of the one or more geographic regions may be assignable to one of a treatment group and a control group of the A/B test. For each of a plurality of the test periods other than a first test period and for each of the one or more geographic regions, the biased probability setting module 310 may set (Block 620) a biased probability indicating a probability of the test period of the geographic region being assigned to the treatment group of the A/B test. The biased probability is set based on a log of previous assignments for the geographic region indicating respective assignments for each previous test period including the first test period. In other embodiments, the biased probability may be set based on logs of previous assignments for other geographic regions and/or the same geographic region in other experiments. The assignment module 320 may assign (Block 630) the test period of the geographic region to one of the treatment and control groups of the A/B test based on the biased probability set at block 620. The test run module 330 may run (Block 640) the A/B test in the geographic region and during the test period based on the assignment at block 630. Based on a comparison of the results of the A/B test, the software update module 240 may determine whether an updated version of the online concierge system with one or more variants should be rolled out in production.

### ADDITIONAL CONSIDERATIONS

The foregoing description of the embodiments has been presented for the purpose of illustration; a person of ordinary skill in the art would recognize that many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include applying the machine learning model to a training example, comparing an output of the machine learning model to the label associated with the training example, and updating weights associated for the machine learning model through a back-propagation process. The weights may be stored on one or more computer-readable media and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present), and B is false (or not present), A is false (or not present), and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present), and C is false (or not present). Similarly, as another not-limiting example, the condition “A, B, or C” is satisfied when A is true (or present), and B and C are false (or not present).

What is claimed is:

1. A computer-implemented method comprising:
setting test periods for an A/B test to be run in one or more geographic regions, each of the test periods in each of the one or more geographic regions being assignable to one of a treatment group and a control group of the A/B test; and
for each of a plurality of the test periods other than a first test period and for each of the one or more geographic regions:
setting a biased probability indicating a probability of the test period of the geographic region being assigned to the treatment group of the A/B test, wherein the biased probability is set based on a log of previous assignments for the geographic region indicating respective assignments for each previous test period including the first test period;
assigning the test period of the geographic region to one of the treatment group and the control group of the A/B test based on the set biased probability; and
running the A/B test in the geographic region and during the test period based on the assignment.

2. The computer-implemented method of claim 1, wherein for each of the plurality of the test periods other than the first test period and for each of the one or more geographic regions, the biased probability is set such that a treatment-to-control ratio in the log of previous assignments trends to a predetermined ratio.

3. The computer-implemented method of claim 2, wherein the treatment-to-control ratio is a ratio of a number of the test periods of the geographic region assigned to the treatment group to a number of the test periods of the geographic region assigned to the control group in the log of previous assignments.

4. The computer-implemented method of claim 1, wherein running the A/B test comprises:
presenting, in each of the one or more geographic regions and for each of the plurality of the test periods that is other than the first test period and that is assigned to the treatment group, a first version of an online concierge system to online users, the first version including one or more variants of the online concierge system that are being tested by the A/B test; and
presenting, in each of the one or more geographic regions and for each of the plurality of test periods that is other than the first test period and that is assigned to the control group, a second version of the online concierge system to the online users, the second version not including the one or more variants of the online concierge system that are being tested by the A/B test.

5. The computer-implemented method of claim 4, further comprising determining whether to update the online concierge system to include the one or more variants based on a result of the A/B test.

6. The computer-implemented method of claim 1, further comprising assigning, for the A/B test and for each of the one or more geographic regions, the first test period of the geographic region to one of the treatment group and the control group randomly.

7. The computer-implemented method of claim 6, further comprising:
for a first geographic region of the one or more geographic regions and for each of the plurality of the test periods other than the first test period for the A/B test:
setting the biased probability for the test period based on a log of previous assignments for the first geographic region indicating respective assignments of each previous test period including the first test period, and based on a treatment-to-control ratio in the log of previous assignments for the first geographic region; and
assigning the test period for the first geographic region to one of the treatment group and the control group based on the set biased probability for the test period; and
for a second geographic region of the one or more geographic regions and for each of the plurality of test periods other than the first test period for the A/B test:
setting the biased probability for the test period based on a log of previous assignments for the second geographic region indicating respective assignments of each previous test period including the first test period, and based on a treatment-to-control ratio in the log of previous assignments for the second geographic region;
determining, based on the log of previous assignments for the first geographic region and the log of previous assignments for the second geographic region, a number of matching test periods having the same assignments;
determining a swarming adjustment factor for the test period based on the determined number of matching test periods and a number of elapsed test periods prior to the test period;
adjusting the biased probability set for the test period based on the swarming adjustment factor; and
assigning the test period for the second geographic region to one of the treatment group and the control group based on the adjusted biased probability for the test period;
wherein the A/B test is run concurrently in the first and second geographic regions based on the assignments.

8. The computer-implemented method of claim 7, wherein the swarming adjustment factor is determined such that a ratio between the determined number of matching test periods and the number of elapsed test periods trends toward a predetermined ratio.

9. The computer-implemented method of claim 6, wherein the A/B test is a first A/B test and wherein the method further comprises:
assigning, for a second A/B test and for each of the one or more geographic regions, the first test period of the geographic region to one of the treatment group and the control group randomly;
for the first A/B test in a first geographic region of the one or more geographic regions and for each of the plurality of the test periods other than the first test period:
setting the biased probability for the test period based on a log of previous assignments for the first A/B test in the first geographic region indicating respective assignments of each previous test period including the first test period, and based on a treatment-to-control ratio in the log of previous assignments for the first A/B test in the first geographic region; and
assigning the test period for the first A/B test in the first geographic region to one of the treatment group and the control group based on the set biased probability for the test period; and
for the second A/B test in the first geographic region and for each of the plurality of the test periods other than the first test period:
setting the biased probability for the test period based on a log of previous assignments for the second A/B test in the first geographic region indicating respective assignments of each previous test period including the first test period, and based on a treatment-to-control ratio in the log of previous assignments for the second A/B test in the first geographic region;
determining, based on the log of previous assignments for the first A/B test and the log of previous assignments for the second A/B test, a number of matching test periods having the same assignments in the first geographic region;
determining a conflict adjustment factor for the test period based on the determined number of matching test periods and a number of elapsed test periods prior to the test period;
adjusting the biased probability set for the test period based on the conflict adjustment factor; and
assigning the test period for the second A/B test in the first geographic region to one of the treatment group and the control group based on the adjusted biased probability for the test period;
wherein the first A/B test and the second A/B test are run concurrently in the first geographic region based on the assignments.

10. The computer-implemented method of claim 9, wherein the conflict adjustment factor is determined such that a ratio between the determined number of matching test periods and the number of elapsed test periods trends toward a predetermined ratio.

11. The computer-implemented method of claim 1, further comprising, for each of the plurality of the test periods other than the first test period and for each of the one or more geographic regions:
determining a day-of-week adjustment factor for the test period of the geographic region based on a treatment-to-control ratio of day-of-week assignments in the log of previous assignments for the geographic region that correspond to a day-of-week of the test period;
adjusting the biased probability set for the test period based on the day-of-week adjustment factor; and
assigning the test period of the geographic region to one of the treatment group and the control group of the A/B test based on the adjusted biased probability for the test period.

12. The computer-implemented method of claim 11, wherein the day-of-week adjustment factor is determined such that the treatment-to-control ratio of the day-of-week assignments in the log of previous assignments for the geographic region that correspond to the day-of-week of the test period trends toward a predetermined ratio.

13. The computer-implemented method of claim 1, wherein each test period is a test day, wherein the method further comprises setting a total number of test days and setting the one or more geographic regions for the A/B test, and wherein the A/B test is run for the total number of test days in the set one or more geographic regions based on the assignments.

14. A non-transitory computer-readable storage medium comprising instructions that, when executed by a processor, cause the processor to:
set test periods for an A/B test to be run in one or more geographic regions, each of the test periods in each of the one or more geographic regions being assignable to one of a treatment group and a control group of the A/B test; and
for each of a plurality of the test periods other than a first test period and for each of the one or more geographic regions:
set a biased probability indicating a probability of the test period of the geographic region being assigned to the treatment group of the A/B test, wherein the biased probability is set based on a log of previous assignments for the geographic region indicating respective assignments for each previous test period including the first test period;
assign the test period of the geographic region to one of the treatment group and the control group of the A/B test based on the set biased probability; and
run the A/B test in the geographic region and during the test period based on the assignment.

15. The non-transitory computer-readable storage medium of claim 14, wherein the instructions that cause the processor to run the A/B test comprise instructions that cause the processor to:
present, in each of the one or more geographic regions and for each of the plurality of the test periods that is other than the first test period and that is assigned to the treatment group, a first version of an online concierge system to online users, the first version including one or more variants of the online concierge system that are being tested by the A/B test; and
present, in each of the one or more geographic regions and for each of the plurality of test periods that is other than the first test period and that is assigned to the control group, a second version of the online concierge system to the online users, the second version not including the one or more variants of the online concierge system that are being tested by the A/B test.

16. The non-transitory computer-readable storage medium of claim 15, further comprising instructions that cause the processor to determine whether to update the online concierge system to include the one or more variants based on a result of the A/B test.

17. The non-transitory computer-readable storage medium of claim 14, further comprising instructions that cause the processor to assign, for the A/B test and for each of the one or more geographic regions, the first test period of the geographic region to one of the treatment group and the control group randomly.

18. The non-transitory computer-readable storage medium of claim 17, further comprising instructions that cause the processor to:
for a first geographic region of the one or more geographic regions and for each of the plurality of the test periods other than the first test period for the A/B test:
set the biased probability for the test period based on a log of previous assignments for the first geographic region indicating respective assignments of each previous test period including the first test period, and based on a treatment-to-control ratio in the log of previous assignments for the first geographic region; and
assign the test period for the first geographic region to one of the treatment group and the control group based on the set biased probability for the test period; and
for a second geographic region of the one or more geographic regions and for each of the plurality of test periods other than the first test period for the A/B test:
set the biased probability for the test period based on a log of previous assignments for the second geographic region indicating respective assignments of each previous test period including the first test period, and based on a treatment-to-control ratio in the log of previous assignments for the second geographic region;
determine, based on the log of previous assignments for the first geographic region and the log of previous assignments for the second geographic region, a number of matching test periods having the same assignments;
determine a swarming adjustment factor for the test period based on the determined number of matching test periods and a number of elapsed test periods prior to the test period;
adjust the biased probability set for the test period based on the swarming adjustment factor; and
assign the test period for the second geographic region to one of the treatment group and the control group based on the adjusted biased probability for the test period;
wherein the A/B test is run concurrently in the first and second geographic regions based on the assignments.

19. The non-transitory computer-readable storage medium of claim 17, wherein the A/B test is a first A/B test and wherein the non-transitory computer-readable storage medium further comprises instructions that cause the processor to:
assign, for a second A/B test and for each of the one or more geographic regions, the first test period of the geographic region to one of the treatment group and the control group randomly;
for the first A/B test in a first geographic region of the one or more geographic regions and for each of the plurality of the test periods other than the first test period:
set the biased probability for the test period based on a log of previous assignments for the first A/B test in the first geographic region indicating respective assignments of each previous test period including the first test period, and based on a treatment-to-control ratio in the log of previous assignments for the first A/B test in the first geographic region; and
assign the test period for the first A/B test in the first geographic region to one of the treatment group and the control group based on the set biased probability for the test period; and
for the second A/B test in the first geographic region and for each of the plurality of the test periods other than the first test period:
set the biased probability for the test period based on a log of previous assignments for the second A/B test in the first geographic region indicating respective assignments of each previous test period including the first test period, and based on a treatment-to-control ratio in the log of previous assignments for the second A/B test in the first geographic region;
determine, based on the log of previous assignments for the first A/B test and the log of previous assignments for the second A/B test, a number of matching test periods having the same assignments in the first geographic region;
determine a conflict adjustment factor for the test period based on the determined number of matching test periods and a number of elapsed test periods prior to the test period;
adjust the biased probability set for the test period based on the conflict adjustment factor; and
assign the test period for the second A/B test in the first geographic region to one of the treatment group and the control group based on the adjusted biased probability for the test period;
wherein the first A/B test and the second A/B test are run concurrently in the first geographic region based on the assignments.

20. An online concierge system, comprising:
one or more hardware processors; and
memory operatively coupled to the one or more hardware processors, the memory comprising instructions that, when executed by the one or more hardware processors, cause the one or more hardware processors to:
set test periods for an A/B test to be run in one or more geographic regions, each of the test periods in each of the one or more geographic regions being assignable to one of a treatment group and a control group of the A/B test; and
for each of a plurality of the test periods other than a first test period and for each of the one or more geographic regions:
set a biased probability indicating a probability of the test period of the geographic region being assigned to the treatment group of the A/B test, wherein the biased probability is set based on a log of previous assignments for the geographic region indicating respective assignments for each previous test period including the first test period;
assign the test period of the geographic region to one of the treatment group and the control group of the A/B test based on the set biased probability; and
run the A/B test in the geographic region and during the test period based on the assignment.
